(19) United States
(12) Patent Application Publication
(10) Pub. No.: US 2025/0206227 A1
(43) Pub. Date: Jun. 26, 2025

(54) VEHICLE MIRROR DEVICE

(71) Applicants: KABUSHIKI KAISHA TOKAI-RIKA-DENKI-SEISAKUSHO, Niwa-gun (JP); TOYOTA JIDOSHA KABUSHIKI KAISHA, Toyota-shi (JP)

(72) Inventors: Yuto NAKAYAMA, Aichi (JP); Toshihiko NISHIMURA, Toyota-shi (JP)

(21) Appl. No.: 18/999,004

(22) Filed: Dec. 23, 2024

(30) Foreign Application Priority Data
Dec. 26, 2023 (JP) 2023-219817

(51) Int. Cl. B60R 1/06

(52) U.S. Cl. CPC B60R 1/06

(57) ABSTRACT

In a door mirror device, a covering section covers a peripheral face of the mirror. The covering section is disposed at least at a portion of a combined range of a vehicle width direction inside and a vehicle width direction outside of the mirror, and the covering section is also not disposed at least at a portion of a combined range of an upper side and a lower side of the mirror. This thereby enables a height direction dimension of the door mirror device to be small.

### CROSS-REFERENCE TO RELATED APPLICATION

This application is based on and claims priority under 35 USC 119 from Japanese Patent Application No. 2023-219817 filed on Dec. 26, 2023, the disclosure of which is incorporated by reference herein.

### BACKGROUND

### Technical Field

The present invention relates to a vehicle mirror device including a covering section that covers a peripheral face of a mirror.

### Related Art

In a mirror retaining structure described in Japanese Patent Application Laid-Open (JP-A) No. 2007-62533, a peripheral edge frame portion of a holder main body covers a peripheral face of a mirror.

In such a mirror retaining structure, the peripheral edge frame portion is disposed at the entire peripheral direction of the mirror.

### SUMMARY

In consideration of the above circumstances, an object of the present invention is to obtain a vehicle mirror device capable of reducing a mirror height direction dimension.

A vehicle mirror device of a first aspect of the present invention includes a mirror provided at a vehicle; and a covering section that covers a peripheral face of the mirror, that is disposed at least at a portion of a combined range of a left side and a right side of the mirror, and that is also not disposed at least at a portion of a combined range of an upper side and a lower side of the mirror.

In the vehicle mirror device of the first aspect of the present invention, the covering section covers the peripheral face of the mirror of the vehicle. Moreover, the covering section is disposed at least at a portion of a combined range of the left side and the right side of the mirror.

The covering section is not disposed at least at a portion of a combined range of the upper side and the lower side of the mirror. This thereby enables the mirror height direction dimension to be made small.

A vehicle mirror device of a second aspect of the present invention is the vehicle mirror device of the first aspect of the present invention, wherein the covering section is disposed at an entirety of the left side and the right side of the mirror and is not disposed at an entirety of the upper side and the lower side of the mirror.

In the vehicle mirror device of the second aspect of the present invention, the covering section is disposed at the entirety of the left side and the right side of the mirror. On the other hand, the covering section is not disposed at the entirety of the upper side and the lower side of the mirror. This thereby enables the mirror height direction dimension to be made small effectively.

A vehicle mirror device of a third aspect of the present invention is the vehicle mirror device of a first aspect or a second aspect of the present invention wherein a perimeter body is disposed at a perimeter of the mirror and projects toward a front-face side of the mirror at a peripheral direction position of the mirror where the covering section is not disposed.

In the vehicle mirror device of the third aspect of the present invention, the perimeter body is disposed at the perimeter of the mirror and the perimeter body projects toward the front-face side of the mirror at a peripheral direction position of the mirror where the covering section is not disposed. This means that at the peripheral direction position the mirror where the covering section of is not disposed, contact with a corner portion between the front-face side surface and the peripheral face of the mirror can be suppressed by the perimeter body.

A vehicle mirror device of a fourth aspect of the present invention is the vehicle mirror device of any one of the first aspect to the third aspect of the present invention, wherein a perimeter body is disposed at a perimeter of the mirror and is configured in a shape indented toward a back-face side of the mirror at a peripheral direction position of the mirror where the covering section is disposed.

In the vehicle mirror device of the fourth aspect of the present invention, the perimeter body is disposed at the perimeter of the mirror, and the perimeter body is configured in a shape indented toward a back-face side of the mirror at a peripheral direction position where the covering section of the mirror is disposed. This means that at the peripheral direction position where the covering section of the mirror is disposed, a vignetting amount due to the perimeter body in the field of view by the mirror can be made small.

A vehicle mirror device of a fifth aspect of the present invention is the vehicle mirror device of any one of the first aspect to the fourth aspect of the present invention, wherein a perimeter body is disposed at a perimeter of the mirror, with the mirror being able to project toward a mirror front-face side at a peripheral direction position of the mirror where the covering section is disposed and the mirror being not able to project toward the mirror front-face side at a peripheral direction position of the mirror where the covering section is not disposed.

In the vehicle mirror device of the fifth aspect of the present invention, the perimeter body is disposed at the perimeter of the mirror, and the mirror is able to project further to the mirror front-face side than the perimeter body at the peripheral direction position the mirror where the covering section of is disposed. On the other hand, the mirror is not able to project further to the mirror front-face side than the perimeter body at the peripheral direction position of the mirror where the covering section is not disposed. Thus at a peripheral direction position of the mirror where the covering section is not disposed, contact with a corner portion between the front-face side surface and the peripheral face of the mirror can be suppressed by the perimeter body.

A vehicle mirror device of a sixth aspect of the present invention is the vehicle mirror device of any one of the first aspect to the fifth aspect of the present invention, wherein a mirror peripheral direction end portion of the covering section is configured so as to become gradually smaller.

In the vehicle mirror device of the sixth aspect of the present invention, the mirror peripheral direction end portion of the covering section is configured so as to become gradually smaller. This means that the appearance can be improved of the mirror peripheral direction end portion of the covering section.

A vehicle mirror device of a seventh aspect of the present invention is the vehicle mirror device of any one of the first aspect to the sixth aspect of the present invention, wherein a perimeter body is disposed at a perimeter of the mirror, and is configured with at least one of a left portion or a right portion that is inclined in a direction toward a left-right direction outside of the mirror on progression toward a front-face side of the mirror.

In the vehicle mirror device of the seventh aspect of the present invention, the perimeter body is disposed at the perimeter of the mirror and at least one of a left portion or a right portion of the perimeter body is inclined in a direction toward a left-right direction outside of the mirror on progression toward a front-face side of the mirror. This enables a vignetting amount in the field of view due to the perimeter body by at least one of the left portion or the right portion of the mirror to be made small.

### BRIEF DESCRIPTION OF THE DRAWINGS

Exemplary embodiments of the present invention will be described in detail based on the following figures, wherein:

FIG. 1A is a perspective view illustrating a door mirror device according to an exemplary embodiment of the present invention, as viewed from a vehicle rear side and vehicle width direction inside;

FIG. 1B is a perspective view illustrating the door mirror device according to the exemplary embodiment of the present invention, as viewed from a vehicle width direction inside;

FIG. 2A is a side view illustrating the door mirror device according to the exemplary embodiment of the present invention, as viewed from a vehicle width direction outside;

FIG. 2B is a side view illustrating the door mirror device according to the exemplary embodiment of the present invention, as viewed from a vehicle width direction inside;

FIG. 3A is a cross-section (cross-section taken along line 3A-3A of FIG. 2A) illustrating the door mirror device according to the exemplary embodiment of the present invention as a whole, as viewed from above;

FIG. 3B is a cross-section (cross-section taken along line 3A-3A of FIG. 2A) illustrating relevant portions of the door mirror device according to the exemplary embodiment of the present invention, as viewed from above;

FIG. 4A is a face-on view illustrating a mirror and a mirror holder of the door mirror device according to the exemplary embodiment of the present invention, as viewed from a vehicle rear;

FIG. 4B is a cross-section (cross-section taken along line 4B-4B of FIG. 4A) illustrating the mirror and the mirror holder of the door mirror device according to the exemplary embodiment of the present invention, as viewed from above;

FIG. 4C is a cross-section (cross-section taken along line 4C-4C of FIG. 4A) illustrating the mirror and the mirror holder of the door mirror device according to the exemplary embodiment of the present invention, as viewed from a vehicle width direction inside; and

FIG. 4D is a face-on view illustrating a corner portion at an upper side and vehicle width direction inside of the mirror and the mirror holder of the door mirror device according to the exemplary embodiment of the present invention, as viewed from a vehicle rear.

### DETAILED DESCRIPTION

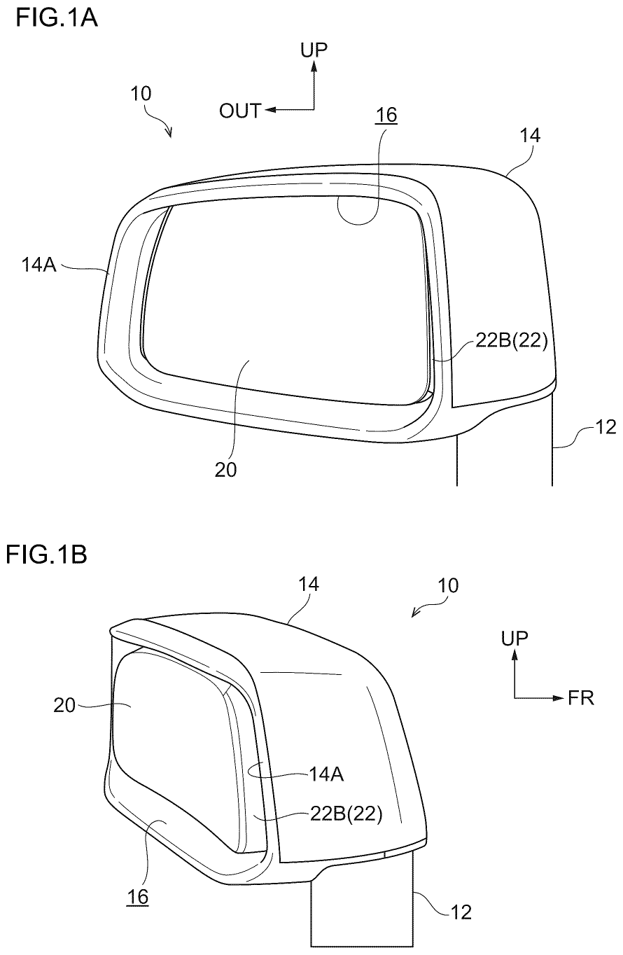

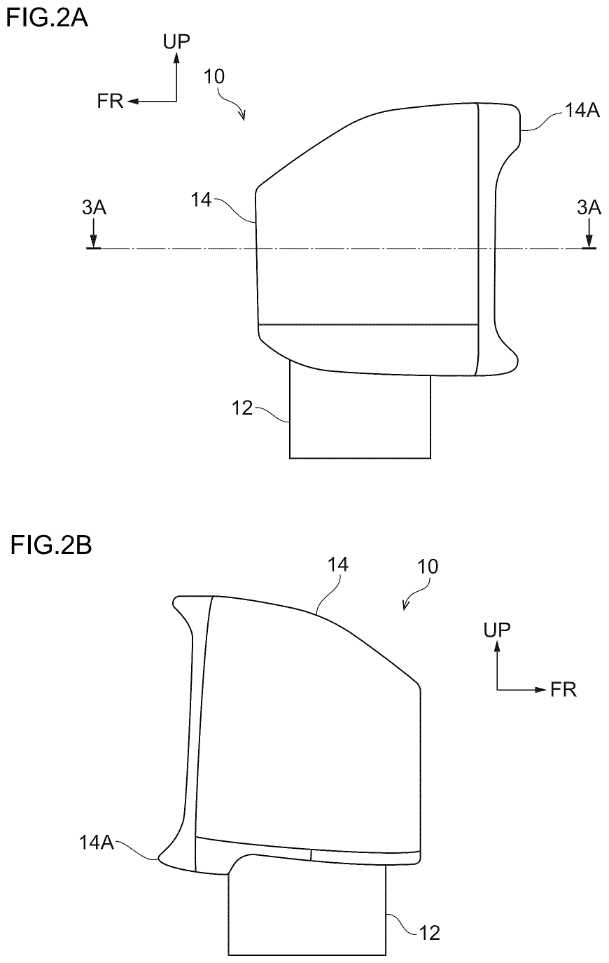

FIG. 1A illustrates a perspective view of a door mirror device 10 serving as a vehicle mirror device according to an exemplary embodiment of the present invention as viewed from a vehicle rear side and vehicle width direction inside, and FIG. 1B illustrates a perspective view of the door mirror device 10 as viewed from the vehicle width direction inside. Furthermore, FIG. 2A illustrates a side view of the door mirror device 10 as viewed from the vehicle width direction outside, and FIG. 2B illustrates a side view of the door mirror device 10 as viewed from the vehicle width direction inside. Note that in these drawings, arrow FR indicates a vehicle forward direction, arrow OUT indicates a vehicle width direction outside (vehicle leftward direction, door mirror device 10 leftward direction), and arrow UP indicates upward.

The door mirror device 10 of the present exemplary embodiment is installed to a vehicle front end section of a height direction intermediate portion of a side door (front side door, omitted in the drawings) of a vehicle (automobile), and is disposed at a vehicle outside of the side door.

As illustrated in FIG. 1A, FIG. 1B, FIG. 2A, and FIG. 2B, a substantially column shaped stay 12 serving as a support body is provided to the door mirror device 10, with the door mirror device 10 installed to the side door by a lower portion of the stay 12 being fixed to the side door.

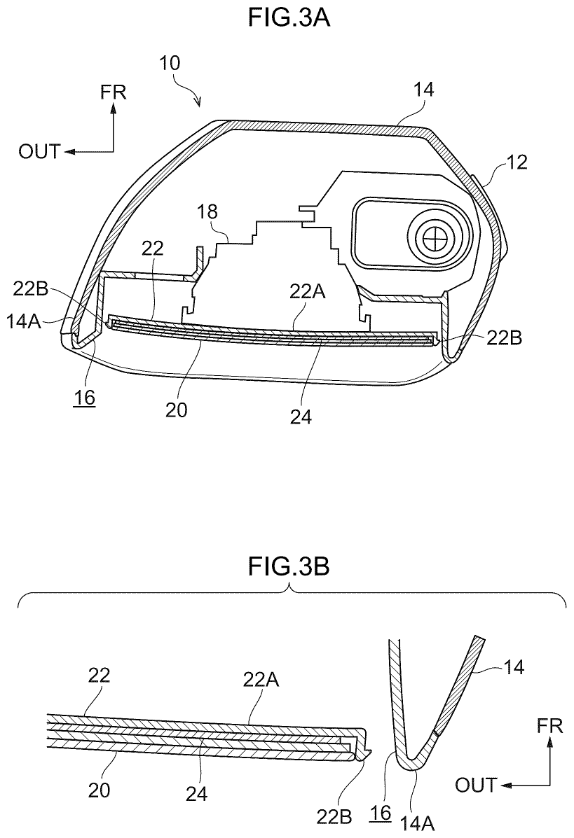

A vehicle width direction inside portion of a substantially cuboidal box shaped visor 14 (see FIG. 3A and FIG. 3B) serving as a perimeter body (cover) is supported at an upper side of the stay 12, with the visor 14 projecting toward the vehicle width direction outside with respect to the stay 12. A vehicle rear side face of the visor 14 is configured as a substantially rectangular shaped opening 16, with the opening 16 opening an interior of the visor 14 toward the vehicle rear side.

A perimeter portion 14A (brim) is provided around the entire peripheral direction of the opening 16 at the outside of the opening 16 of the visor 14. A vehicle width direction outside portion of the perimeter portion 14A is inclined toward the vehicle width direction outside on progression downward, with a portion on the upper side and vehicle width direction inside of the perimeter portion 14A, a portion on the upper side and vehicle width direction outside thereof, a portion on the lower side and vehicle width direction inside thereof, and a portion on a lower side and vehicle width direction outside thereof, each curved in a convex shape in the peripheral direction of the perimeter portion 14A (peripheral direction of the opening 16). A cross-section taken along the width direction (thickness direction) of the perimeter portion 14A is configured with a substantially V-shape that decreases toward the vehicle rear side, and a vehicle rear side end face (leading end face) of the perimeter portion 14A is curved in a convex shape in the width direction of the perimeter portion 14A, with an increased radius of curvature (for example, 2.5 mm or greater). A vehicle width direction inside face (opening 16 side face) of a vehicle width direction outside portion of the perimeter portion 14A is inclined in a direction toward the vehicle width direction outside (opposite side from the opening 16) on progression toward the vehicle rear side. An upper side portion and a lower side portion of the perimeter portion 14A project toward the vehicle rear side with respect to a vehicle width direction inside portion and a vehicle width direction outside portion of the perimeter portion 14A, and the vehicle width direction inside portion and the vehicle width direction outside portion of the perimeter portion 14A are configured with a shape indented toward the vehicle front side with respect to the upper side portion and the lower side portion of the perimeter portion 14A. A vehicle rear side end face of a portion on the upper side and vehicle width direction inside of the perimeter portion 14A, a portion on the upper side and vehicle width direction outside thereof, a portion on the lower side and vehicle width direction inside thereof, and a portion on a lower side and vehicle width direction outside thereof, are each inclined toward the vehicle rear side on progression toward the height direction outsides of the visor 14.

An adjustment device 18 (see FIG. 3A) serving as a displacement mechanism is fixed to the inside of the visor 14, with the adjustment device 18 projecting inside a perimeter portion 14A of the visor 14.

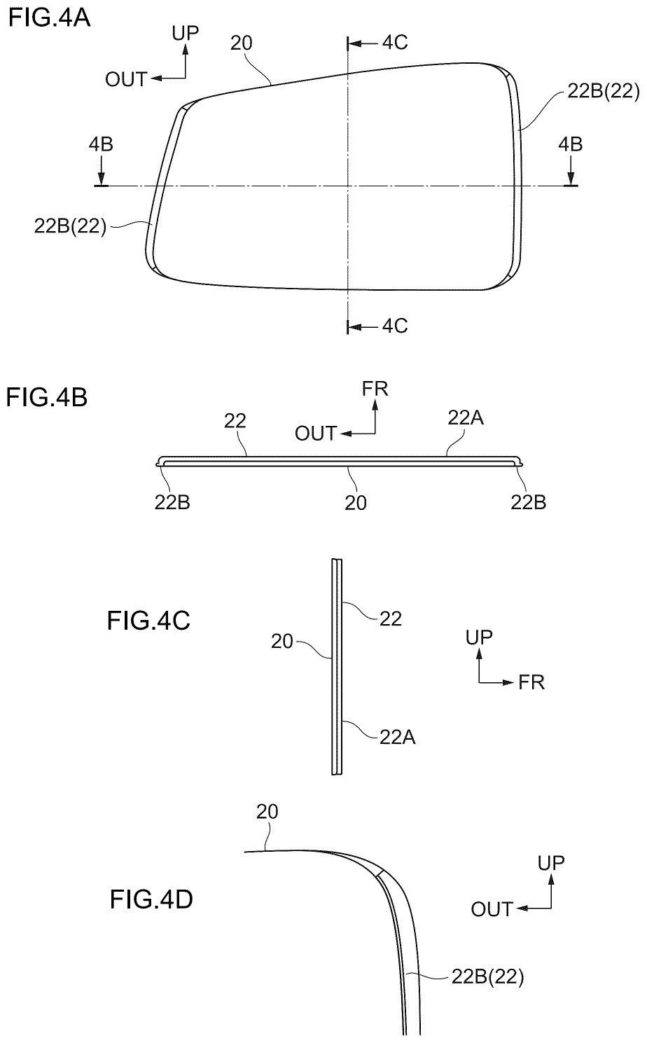

A substantially rectangular plate shaped mirror 20 (see FIG. 3A, FIG. 3B, and FIG. 4A to FIG. 4D) is disposed at the inside of the perimeter portion 14A of the visor 14, with the mirror 20 disposed further toward the vehicle front side than a vehicle rear side end face of the entire perimeter portion 14A (see FIG. 3A). A peripheral face of the mirror 20 is disposed along the perimeter portion 14A, the peripheral face at the vehicle width direction outside portion of the mirror 20 is inclined in a direction toward the vehicle width direction outside on progression downward, and also a peripheral face at the upper side and vehicle width direction inside of the mirror 20, a peripheral face at the upper side and vehicle width direction outside thereof, a peripheral face at the lower side and vehicle width direction inside thereof, and a peripheral face at the lower side and vehicle width direction outside thereof, are each curved in a convex shape in a peripheral direction of the mirror 20. A front-face side of the mirror 20 is exposed to the vehicle rear side through the opening 16 of the visor 14, and viewing of an occupant of a vehicle toward the vehicle rear side is assisted by the occupant viewing light reflected by the mirror 20 from the vehicle width direction inside of the mirror 20. A radius of curvature of a corner portion between the front-face side surface and the peripheral face of the mirror 20 is smaller than the radius of curvature of a vehicle rear side end face of the perimeter portion 14A.

A back-face side and the outer periphery of the mirror 20 is covered by a mirror holder 22 serving as a covering member. A substantially rectangular plate shaped holder main body 22A is provided to the mirror holder 22 at the mirror 20 back-face side thereof, and the back-face side surface of the mirror 20 is fixed to the holder main body 22A by, for example, a double-sided tape 24.

A substantially elongated plate shaped covering section 22B is provided to a vehicle width direction inside and a vehicle width direction outside at an outer periphery of the mirror holder 22, with the covering section 22B projecting from the holder main body 22A toward the vehicle rear side and covering a peripheral face of the mirror 20. A vehicle rear side end portion (leading end portion) of the covering section 22B is configured with a substantially trapezoidal shaped cross-section, projects toward the outside of the mirror holder 22 (opposite side from the mirror 20), and a vehicle rear side end face (leading end face) of the covering section 22B is curved in a convex shape in a thickness direction of the covering section 22B. A radius of curvature of a vehicle rear side end face of the covering section 22B is configured larger than a radius of curvature of a corner portion between the front-face side surface and the peripheral face of the mirror 20, and is also configured the same as a radius of curvature of a vehicle rear side end face of the perimeter portion 14A of the visor 14 (for example, 2.5 mm or greater), and the vehicle rear side end face of the covering section 22B is disposed at a position substantially flush with a front-face side surface of the mirror 20.

A width direction (vehicle front-rear direction) dimension and a thickness direction dimension of a length direction (mirror 20 peripheral direction) end portion of the covering section 22B at a peripheral face of the upper side and vehicle width direction inside of the mirror 20, a peripheral face at the upper side and vehicle width direction outside thereof, a peripheral face at the lower side and vehicle width direction inside thereof, and a peripheral face at the lower side and vehicle width direction outside thereof, are gradually smaller on progression toward height direction outsides of the mirror holder 22, and both length direction end faces (upper end face and lower end face) of the covering section 22B are inclined in a direction toward a vehicle front side on progression toward height direction outsides of the mirror holder 22.

The vehicle front side of the mirror holder 22 (the holder main body 22A) is attached to the adjustment device 18, and the mirror 20 and the mirror holder 22 are tilted (displaced) by a specific range in the height direction and the vehicle width direction by the adjustment device 18 being operated, and a direction of viewing for the occupant using the mirror 20 is adjusted. When the mirror 20 is tilted in the height direction, the upper portion of the mirror 20 is always disposed further toward the vehicle front side (perimeter portion 14A inside) than the vehicle rear side end face of the upper side portion of the perimeter portion 14A of the visor 14, and also the lower portion of the mirror 20 is always disposed further toward the vehicle front side (perimeter portion 14A inside) than the vehicle rear side end face of the lower side portion of the perimeter portion 14A. When the mirror 20 is tilted in the vehicle width direction, the vehicle width direction inside portion of the mirror 20 is able to be disposed further toward the vehicle rear side (perimeter portion 14A outside) than the vehicle rear side end face of the vehicle width direction inside portion of the perimeter portion 14A, and also the vehicle width direction outside portion of the mirror 20 is able to be disposed further toward the vehicle rear side (perimeter portion 14A outside) than the vehicle rear side end face of the vehicle width direction outside portion of the perimeter portion 14A (see FIG. 1B).

Next, description follows regarding operation and advantageous effects of the present exemplary embodiment.

In the door mirror device 10 configured as described above, the peripheral face of the mirror 20 is covered by the covering section 22B of the mirror holder 22, and the perimeter portion 14A of the visor 14 is disposed at the perimeter of the mirror 20 and the mirror holder 22.

The covering section 22B is disposed in at least a portion of a combined range of the vehicle width direction inside and the vehicle width direction outside of the mirror 20, and the covering section 22B is not disposed in at least a portion of a combined range of the upper side and the lower side of the mirror 20. This means that the height direction dimensions of the mirror 20 and the mirror holder 22 can be made smaller, and the height direction dimension of the door mirror device 10 can be made smaller.

Moreover, although the covering section 22B is disposed at the entirety of the vehicle width direction inside and the vehicle width direction outside of the mirror 20, the covering section 22B is not disposed at the entirety of the upper side and the lower side of the mirror 20. This means that the height direction dimensions of the mirror 20 and the mirror holder 22 can be made smaller effectively, and the height direction dimension of the door mirror device 10 can be made smaller effectively.

Moreover, at peripheral direction positions of the mirror 20 where the covering section 22B is not disposed (the entirety of the upper side and the lower side of the mirror 20), the perimeter portion 14A of the visor 14 projects toward the vehicle rear side (mirror 20 front-face side). This means that in the entirety of the upper side and the lower side of the mirror 20, even without the covering section 22B being disposed on the mirror 20, human contact with a corner portion between the front-face side surface and the peripheral face of the mirror 20 can be suppressed by the vehicle rear side end face of the perimeter portion 14A. Furthermore, an occupant observes the mirror 20 from the vehicle width direction inside, and so even if the perimeter portion 14A projects toward the vehicle rear side at the entirety of the upper side and the lower side of the mirror 20, a vignetting amount due to the perimeter portion 14A in the field of view of the occupant by the mirror 20 can be made small.

Moreover, when the mirror 20 is tilted in the height direction by the adjustment device 18, the upper portion of the mirror 20 is always disposed further toward the vehicle front side than the vehicle rear side end face of the upper side portion of the perimeter portion 14A of the visor 14, and the lower portion of the mirror 20 is always disposed further toward the vehicle front side than the vehicle rear side end face of the lower side portion of the perimeter portion 14A. This means that at the entirety of the upper side and the lower side of the mirror 20, human contact with a corner portion between the front-face side surface and the peripheral face of the mirror 20 can be suppressed effectively by the vehicle rear side end face of the perimeter portion 14A.

Furthermore, at peripheral direction positions of the mirror 20 where the covering section 22B is disposed (the entirety of the vehicle width direction inside and the vehicle width direction outside of the mirror 20), the perimeter portion 14A of the visor 14 is configured with a shape indented toward the vehicle front side (mirror 20 back-face side). This means that even if the perimeter portion 14A does not project toward the vehicle rear side at the entirety of the vehicle width direction inside and the vehicle width direction outside of the mirror 20, human contact with a corner portion between the front-face side surface and the peripheral face of the mirror 20 can be suppressed by the vehicle rear side end face of the covering section 22B. Furthermore, due to an occupant observing the mirror 20 from the vehicle width direction inside, at the vehicle width direction inside and vehicle width direction outside of the mirror 20, although a vignetting amount due to the perimeter portion 14A in the field of view of the occupant by the mirror 20 is liable to be greater than at the upper side and the lower side of the mirror 20, over the entirety of the vehicle width direction inside and the vehicle width direction outside of the mirror 20, due to the perimeter portion 14A being a shape indented toward the vehicle front side, the vignetting amount due to perimeter portion 14A in the field of view of the occupant by the mirror 20 can be made small effectively.

Moreover, when the mirror 20 is tilted in the vehicle width direction by the adjustment device 18, a vehicle width direction inside portion of the mirror 20 is able to be disposed further to the vehicle rear side than the vehicle rear side end face of the vehicle width direction inside portion of the perimeter portion 14A, and also the vehicle width direction outside portion of the mirror 20 is able to be disposed further toward the vehicle rear side than the vehicle rear side end face of the vehicle width direction outside portion of the perimeter portion 14A. This means that over the entirety of the vehicle width direction inside and the vehicle width direction outside of the mirror 20, even if the mirror 20 is disposed further toward the vehicle rear side than the vehicle rear side end face of the perimeter portion 14A, human contact with a corner portion between the front-face side surface and the peripheral face of the mirror 20 can be suppressed by the vehicle rear side end face of the covering section 22B.

Moreover, a vehicle width direction inside face (mirror 20 side face) of the vehicle width direction outside portion of the perimeter portion 14A of the visor 14 is inclined in a direction toward the vehicle width direction outside (opposite side from the mirror 20) on progression toward the vehicle rear side (mirror 20 front-face side). This means that a vignetting amount due to the perimeter portion 14A in the field of view of the occupant by the vehicle width direction outside portion of the mirror 20 can be made small effectively.

Moreover, a vehicle width direction outside portion of the perimeter portion 14A of the visor 14 is inclined in a direction toward the vehicle width direction outside on progression downward, and a peripheral face of the vehicle width direction outside of the mirror 20 is inclined toward the vehicle width direction outside on progression downward. This means that the mirror 20 can be large at the vehicle width direction outside, and a field of view of the occupant by the mirror 20 can be large.

Furthermore, the width direction dimension and the thickness dimension of a length direction end portion of the covering section 22B at the peripheral face at the upper side and vehicle width direction inside of the mirror 20, at the peripheral face at the upper side and vehicle width direction outside thereof, at the peripheral face at the lower side and vehicle width direction inside thereof, and at the peripheral face at the lower side and vehicle width direction outside thereof, are gradually smaller on progression toward the height direction outsides of the mirror holder 22. This means that generation of a boundary between a peripheral direction region of the mirror 20 where the covering section 22B is disposed, and a peripheral direction region of the mirror 20 where the covering section 22B is not disposed, can be suppressed. Moreover, the appearance of the length direction end portion of the covering section 22B can be improved.

Note that in the present exemplary embodiment, the radius of curvature of the vehicle rear side end face of the perimeter portion 14A of the visor 14 and the radius of curvature of the vehicle rear side end face of the covering section 22B of the mirror 20 are made the same as each other. However, the radius of curvature of the vehicle rear side end face of the perimeter portion 14A of the visor 14 may be larger than the radius of curvature of the vehicle rear side end face of the covering section 22B of the mirror 20, and the radius of curvature of the vehicle rear side end face of the perimeter portion 14A of the visor 14 may be smaller than the radius of curvature of the vehicle rear side end face of the covering section 22B of the mirror 20.

Furthermore, in the present exemplary embodiment, the covering section 22B is disposed at the entirety of the vehicle width direction inside and the vehicle width direction outside of the mirror 20, and also is not disposed at the entirety of the upper side and the lower side of the mirror 20. However, the covering section 22B may be disposed at least at a portion of a combined range of the vehicle width direction inside and the vehicle width direction outside of the mirror 20, and may not be disposed at least at a portion of a combined range of the upper side and the lower side of the mirror 20.

In the present exemplary embodiment, the vehicle width direction inside face of the vehicle width direction outside portion of the perimeter portion 14A of the visor 14 is inclined in a direction toward the vehicle width direction outside on progression toward the vehicle rear side. However, the vehicle width direction outside face of the vehicle width direction inside portion of the perimeter portion 14A of the visor 14 may be inclined in a direction toward the vehicle width direction inside on progression toward the vehicle rear side.

Furthermore, in the present exemplary embodiment, the vehicle width direction outside portion of the perimeter portion 14A of the visor 14 is inclined in a direction toward the vehicle width direction outside on progression downward, and the peripheral face at the vehicle width direction outside of the mirror 20 is inclined in a direction toward the vehicle width direction outside on progression downward. However, the vehicle width direction outside portion of the perimeter portion 14A of the visor 14 may be inclined in a direction toward the vehicle width direction outside on progression upward, and the peripheral face at the vehicle width direction outside of the mirror 20 may be inclined in a direction toward the vehicle width direction outside on progression upward. Furthermore, the vehicle width direction inside portion of the perimeter portion 14A of the visor 14 may be inclined in a direction toward the vehicle width direction inside on progression downward and the peripheral face at the vehicle width direction inside of the mirror 20 may be inclined in a direction toward the vehicle width direction inside on progression downward, or the vehicle width direction inside portion of the perimeter portion 14A of the visor 14 may be inclined in a direction toward the vehicle width direction inside on progression upward and the peripheral face at the vehicle width direction inside of the mirror 20 may be inclined in a direction toward the vehicle width direction inside on progression upward.

Moreover, in the present exemplary embodiment, the vehicle mirror device is applied to the door mirror device 10. However, the vehicle mirror device may be applied to a mirror device other than the door mirror device 10 (for example, by a fender mirror device) of a vehicle.

What is claimed is:

1. A vehicle mirror device, comprising:
a mirror provided at a vehicle; and
a covering section that covers a peripheral face of the mirror, that is disposed at least at a portion of a combined range of a left side and a right side of the mirror, and that is also not disposed at least at a portion of a combined range of an upper side and a lower side of the mirror.

2. The vehicle mirror device of claim 1, wherein the covering section is disposed at an entirety of the left side and the right side of the mirror and is not disposed at an entirety of the upper side and the lower side of the mirror.

3. The vehicle mirror device of claim 1, wherein a perimeter body is disposed at a perimeter of the mirror and projects toward a front-face side of the mirror at a peripheral direction position of the mirror where the covering section is not disposed.

4. The vehicle mirror device of claim 1, wherein a perimeter body is disposed at a perimeter of the mirror and is configured in a shape indented toward a back-face side of the mirror at a peripheral direction position of the mirror where the covering section is disposed.

5. The vehicle mirror device of claim 1, wherein a perimeter body is disposed at a perimeter of the mirror, with the mirror being able to project toward a mirror front-face side at a peripheral direction position of the mirror where the covering section is disposed and the mirror being not able to project toward the mirror front-face side at a peripheral direction position of the mirror where the covering section is not disposed.

6. The vehicle mirror device of claim 1, wherein a mirror peripheral direction end portion of the covering section is configured so as to become gradually smaller.

7. The vehicle mirror device of claim 1, wherein a perimeter body is disposed at a perimeter of the mirror, and is configured with at least one of a left portion or a right portion that is inclined in a direction toward a left-right direction outside of the mirror on progression toward a front-face side of the mirror.

8. The vehicle mirror device of claim 1, wherein:
at least one of a left portion or a right portion of the mirror is inclined in a left-right direction with respect to a height direction; and
a perimeter body is disposed at a perimeter of the mirror, and includes at least one of a left portion or a right portion inclined in a direction toward at least one of the left portion or the right portion of the mirror.

9. The vehicle mirror device of claim 1, wherein a perimeter body is disposed at a perimeter of the mirror, a peripheral direction position of the mirror where the covering section is not disposed being not disposed further toward a front-face side of the mirror than the perimeter body in a case in which the mirror has been tilted.

10. The vehicle mirror device of claim 1, wherein a perimeter body is disposed at a perimeter of the mirror, a peripheral direction position of the mirror where the covering section is disposed being disposed further toward a front-face side of the mirror than the perimeter body in a case in which the mirror has been tilted.
